(19) United States
(12) Patent Application Publication
(10) Pub. No.: US 2017/0364598 A1
(43) Pub. Date: Dec. 21, 2017

(54) METHODS, SYSTEMS, AND MEDIA FOR PRESENTING LINKS TO MEDIA CONTENT

(71) Applicant: Google Inc., Mountain View, CA (US)

(72) Inventor: Satyajeet Salgar, Mountain View, CA (US)

(21) Appl. No.: 15/525,516

(22) PCT Filed: Nov. 19, 2015
(86) PCT No.: PCT/US2015/061636

§ 371 Date: May 9, 2017

Related U.S. Application Data
(60) Provisional application No. 62/082,057, filed on Nov. 19, 2014.

(51) Int. Cl. G06F 17/30; G06F 3/0482; G06Q 30/06

(52) U.S. Cl. CPC G06F 17/30867; G06Q 30/0621; G06F 3/0482; G06F 17/30029

(57) ABSTRACT

Methods, systems, and media for presenting links to media content are provided. In accordance with some implementations, a method for presenting links to media content is provided, the method comprising: receiving, from a user device, a search query for a media content item; identifying candidate providers that provide access to the media content item; receiving, for each candidate provider, provider interaction information relating to previous interactions between a user of the user device and a candidate provider; receiving, for each candidate providers, media link information related to links to the media content item by the candidate provider; ranking the candidate providers based on the provider interaction information and the media link information; identifying a subset of candidate providers to be associated with a presented link to the media content item based at least in part on the ranking; and causing a user interface with links to the media content item to be presented, wherein each link of links is associated with one of the subset of candidate providers.

### CROSS REFERENCE TO RELATED APPLICATIONS

This application claims the benefit of U.S. Provisional Patent Application No. 62/082,057, filed Nov. 19, 2014, which is hereby incorporated by reference herein in its entirety.

### TECHNICAL FIELD

The disclosed subject matter relates to methods, systems, and media for presenting links to media content.

### BACKGROUND

Users often use different media content providers to view media content items, such as movies and/or television programs. For example, users may use media content providers that provide access to the media content items via download and/or via streaming to a particular user device. In some instances, multiple media content providers may provide access to the same media content item, each for a different price. In some such instances, users may enter a search query for the media content item to identify media content providers that provide access to the media content item. However, it can be difficult to determine which of several media content providers returned from the search query to present for consuming the media content item.

Accordingly, it is desirable to provide new methods, systems, and media for presenting links to media content.

### SUMMARY

Methods, systems, and media for presenting links to media content are provided.

In accordance with some implementations of the disclosed subject matter, a method for presenting links to media content is provided, the method comprising: receiving, from a user device, a search query for a media content item; identifying a plurality of candidate providers that provide access to the media content item; receiving, for each of the plurality of candidate providers, provider interaction information relating to previous interactions between a user of the user device and a candidate provider; receiving, for each of the plurality of candidate providers, media link information related to links to the media content item by the candidate provider; ranking the plurality of candidate providers based on the provider interaction information and the media link information; identifying a subset of the plurality of candidate providers to be associated with a presented link to the media content item based at least in part on the ranking; and causing a user interface with a plurality of links to the media content item to be presented, wherein each link of the plurality of links is associated with one of the subset of the plurality of candidate providers.

In accordance with some implementations of the disclosed subject matter, a system for presenting links to media content is provided, the system comprising a hardware processor that is configured to: receive, from a user device, a search query for a media content item; identify a plurality of candidate providers that provide access to the media content item; receive, for each of the plurality of candidate providers, provider interaction information relating to previous interactions between a user of the user device and a candidate provider; receive, for each of the plurality of candidate providers, media link information related to links to the media content item by the candidate provider; rank the plurality of candidate providers based on the provider interaction information and the media link information; identify a subset of the plurality of candidate providers to be associated with a presented link to the media content item based at least in part on the ranking; and cause a user interface with a plurality of links to the media content item to be presented, wherein each link of the plurality of links is associated with one of the subset of the plurality of candidate providers.

In accordance with some implementations of the disclosed subject matter, a non-transitory computer-readable medium containing computer-executable instructions that, when executed by a processor, cause the processor to perform a method for presenting links to media content, is provided. The method comprises: receiving, from a user device, a search query for a media content item; identifying a plurality of candidate providers that provide access to the media content item; receiving, for each of the plurality of candidate providers, provider interaction information relating to previous interactions between a user of the user device and a candidate provider; receiving, for each of the plurality of candidate providers, media link information related to links to the media content item by the candidate provider; ranking the plurality of candidate providers based on the provider interaction information and the media link information; identifying a subset of the plurality of candidate providers to be associated with a presented link to the media content item based at least in part on the ranking; and causing a user interface with a plurality of links to the media content item to be presented, wherein each link of the plurality of links is associated with one of the subset of the plurality of candidate providers.

In accordance with some implementations of the disclosed subject matter, a system for presenting links to media content is provided, the system comprising: means for receiving, from a user device, a search query for a media content item; means for identifying a plurality of candidate providers that provide access to the media content item; means for receiving, for each of the plurality of candidate providers, provider interaction information relating to previous interactions between a user of the user device and a candidate provider; means for receiving, for each of the plurality of candidate providers, media link information related to links to the media content item by the candidate provider; means for ranking the plurality of candidate providers based on the provider interaction information and the media link information; means for identifying a subset of the plurality of candidate providers to be associated with a presented link to the media content item based at least in part on the ranking; and means for causing a user interface with a plurality of links to the media content item to be presented, wherein each link of the plurality of links is associated with one of the subset of the plurality of candidate providers.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 shows a schematic diagram of an example of a system for presenting links to media content in accordance with some implementations of the disclosed subject matter.

FIG. 2 shows an example of hardware that can be used in a server and/or a user device in accordance with some implementations of the disclosed subject matter.

FIGS. 3A-3C show examples of user interfaces for presenting links to media content based on a received search query in accordance with some implementations of the disclosed subject matter.

FIG. 4 shows an example of a process for presenting links to media content based on a ranking of providers of the media content in accordance with some implementations of the disclosed subject matter.

FIG. 5 shows an example of a process for generating a ranking score for a provider of media content based on various criteria relating to the provider in accordance with some implementations of the disclosed subject matter.

### DETAILED DESCRIPTION

In accordance with various implementations, mechanisms (which can include methods, systems, and media) for presenting links to media content are provided.

In some implementations, the mechanisms can receive a search query that requests a particular media content item, such as a television program, a movie, a video, a song, an audiobook, and/or any other suitable media content item. The mechanisms can then identify a group of candidate providers that provide access to the media content item. In some implementations, a candidate provider can allow a user having a user device to download the media content item to the user device, can allow a user to stream the media content item to a user device, and/or can provide access to the media content item in any other suitable manner. In some implementations, access to the media content item can be available upon payment of a fee and/or with a subscription to a service associated with the candidate provider.

In some implementations, the mechanisms can receive information associated with each of the candidate providers. For example, in some implementations, the information can include information regarding whether the candidate provider is associated with an application available for download on a user device (e.g., a mobile device application), information relating to the popularity of the candidate provider, information regarding whether the candidate provider is an official and/or the only provider of the media content item, information regarding whether the candidate provider provides direct links to the media content item (rather than a link to a general web page associated with the provider), historical information relating to user device interactions with the candidate provider, and/or any other suitable information. The mechanisms can then classify and/or rank the candidate providers based on the received information (e.g., account preference information, provider experience information, content availability information, pricing information, popularity information, etc.). For example, the mechanisms can determine a ranking score for each candidate provider that applies a weight to each piece of received information and can rank order the candidate providers based on the determined ranking score.

In some implementations, the mechanisms can then cause a user interface with one or more links to the media content item to be presented, where each link is associated with a different provider. In some implementations, inclusion in the group of links presented in the user interface can be based on the ranking and/or based on any suitable criteria. For example, in some implementations, the user interface can present links associated with the top N (e.g., two, three, five, and/or any other suitable number) candidate providers based on the ranking. As another example, in some implementations, the user interface can present links associated with candidate providers that meet particular criteria (e.g., those that provide direct links to the media content item, those that a user associated with a user device that received the search query has a subscription to, those that provide free access to content, and/or based on any other suitable criteria). In some implementations, selection of a presented link can cause the media content item to be downloaded from the associated provider and/or streamed to a user device from the associated provider.

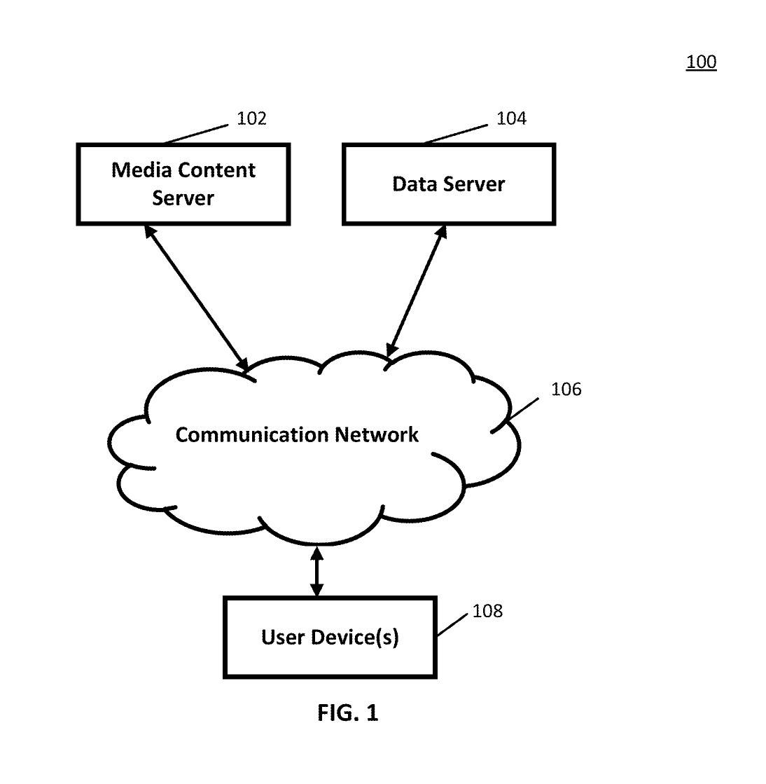

Turning to FIG. 1, an example 100 of hardware for presenting links to video content that can be used in accordance with some implementations of the disclosed subject matter is shown. As illustrated, hardware 100 can include one or more servers, such as a media content server 102, a data server 104, a communication network 106, and one or more user devices 108.

Media content server 102 can be any suitable server for storing media content and delivering the media content to a user device 108 in some implementations. For example, media content server 102 can be a server that streams media content to user device 108 via communication network 106. As a more particular example, in some implementations, media content server 102 can stream media content to user device 108 in response to receiving a request for the media content from user device 108. Content provided by media content server 102 can be any suitable content, such as video content, audio content, television programs, movies, cartoons, sound effects, audiobooks, streaming live content (e.g., a streaming radio show, a live concert, and/or any other suitable type of streaming live content), electronic books, search results and/or any other suitable type of content. Content can be created and uploaded to media content server 102 by any suitable entity. In some implementations, media content server 102 can be associated with a particular media content provider, such as a particular media content hosting service, a particular media content streaming service, a particular media content management service, and/or any other suitable media content provider.

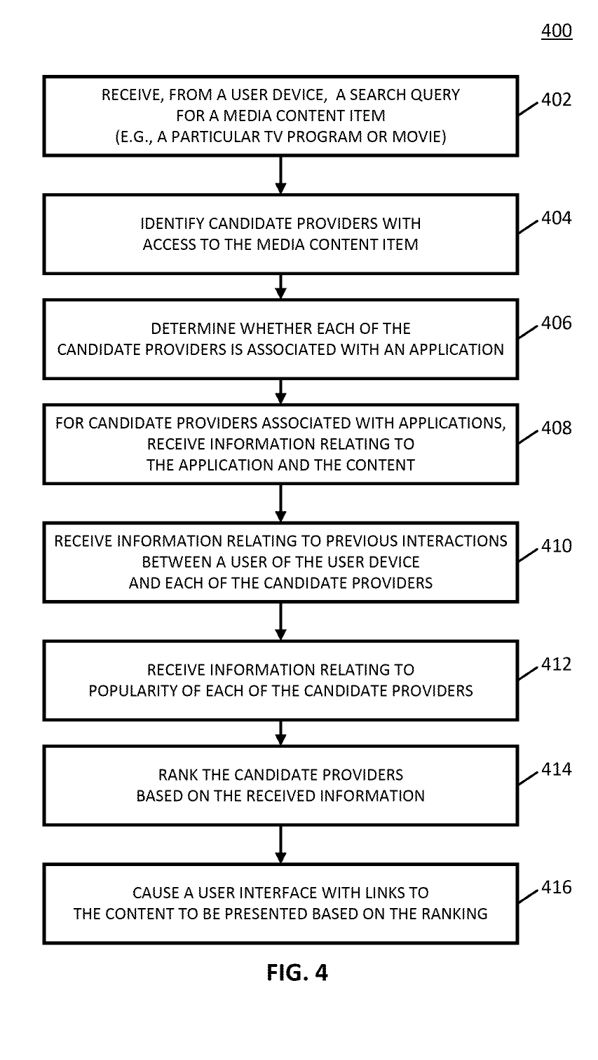

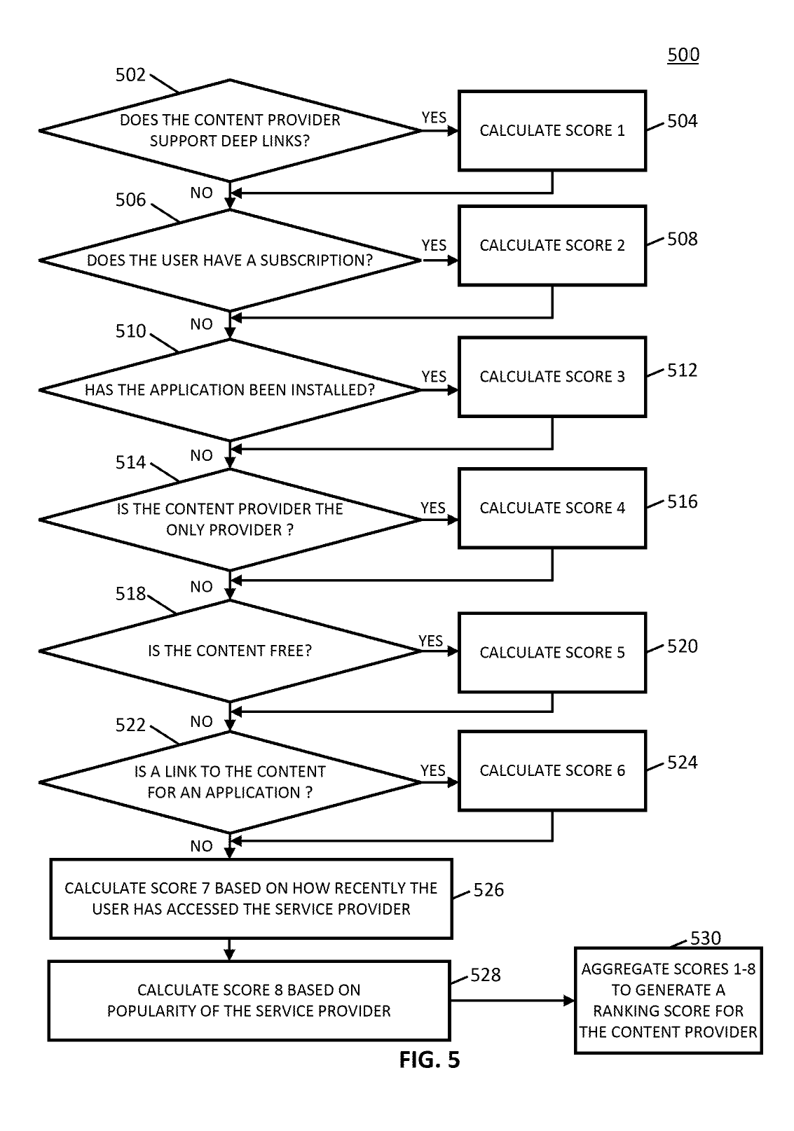

Data server 104 can be any suitable server for storing information about media content providers, information about a user's or user device's interaction with particular media content providers, and/or any other suitable information. For example, in some implementations, data server 104 can store information relating to an application (e.g., that is installed on and executed from a device such as a mobile phone, a tablet computer, and/or any other suitable user device) associated with a particular media content provider. As a more particular example, in some implementations, the information can include information regarding whether the application supports deep links to content, popularity information relating to the application (e.g., how many times the application has been installed, how frequently the application is used, and/or any other suitable information), and/or price information relating to the application (e.g., a downloadable mobile device application) and/or content associated with the application. As another example, in some implementations, data server 104 can store information relating to a user's interactions with a particular media content provider. As a more particular example, in some implementations, the information can include information regarding whether an application associated with the media content provider has been installed on user device 108, information regarding whether the user has subscribed to a service offered by the media content provider, and/or any other suitable information. In some implementations, information stored on data server 104 can be used to rank different media content providers, as shown in and described below in connection with FIGS. 4 and 5.

Communication network 106 can be any suitable combination of one or more wired and/or wireless networks in some implementations. For example, communication network 106 can include any one or more of the Internet, a mobile data network, a satellite network, a local area network, a wide area network, a telephone network, a cable television network, a WiFi network, a WiMax network, and/or any other suitable communication network.

User device(s) 108 can include any one or more user devices suitable for searching for an item of media content, receiving one or more links to the media content, and selecting one of the links to the media content. For example, in some implementations, user device(s) 108 can include mobile devices, such as a mobile phone, a tablet computer, a laptop computer, a vehicle (e.g., a car, a boat, an airplane, or any other suitable vehicle) entertainment system, a portable media player, or any other suitable mobile device. As another example, in some implementations, user device(s) 108 can include non-mobile devices such as a desktop computer, a set-top box, a television, a streaming media player, a game console, or any other suitable non-mobile device.

Although media content server 102 and data server 104 are illustrated as separate devices, any one or more of these devices can be combined into one device in some implementations. Also, although only one each of media content server 102 and data server 104 are shown in FIG. 1 to avoid over-complicating the figure, any suitable one or more of each device can be used in some implementations.

Although only one user device 108 is shown in FIG. 1 to avoid over-complicating the figure, any suitable number of each of these devices, and any suitable types of these devices, can be used in some implementations.

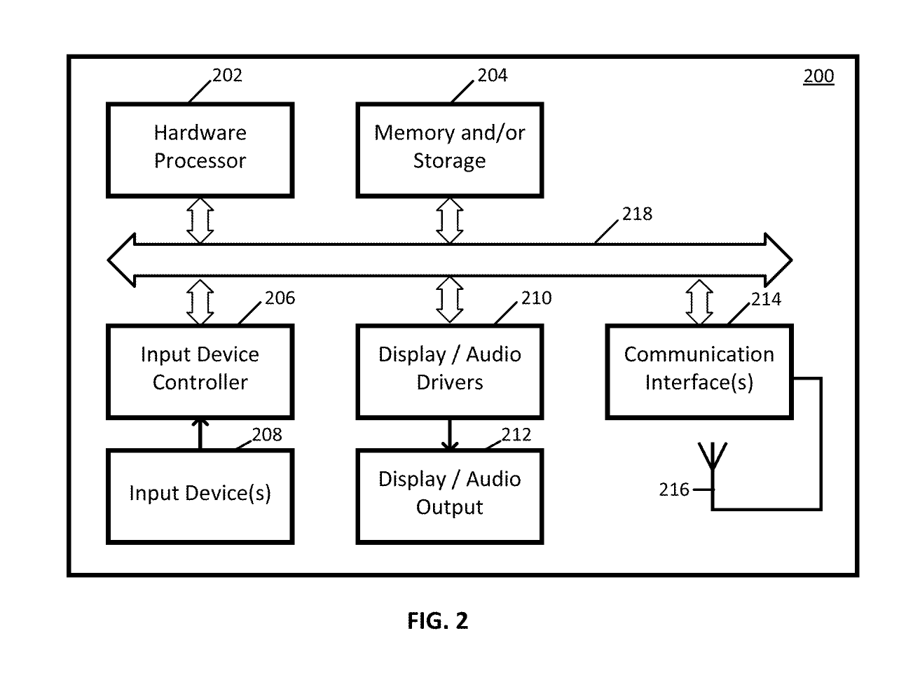

Media content server 102, data server 104, and user device 108 can be implemented using any suitable hardware in some implementations. For example, in some implementations, devices 102, 104, and 108 can be implemented using any suitable general purpose computer or special purpose computer. For example, a server may be implemented using a special purpose computer. Any such general purpose computer or special purpose computer can include any suitable hardware. For example, as illustrated in example hardware 200 of FIG. 2, such hardware can include hardware processor 202, memory and/or storage 204, an input device controller 206, an input device 208, display/audio drivers 210, display and audio output circuitry 212, communication interface(s) 214, an antenna 216, and a bus 218.

Hardware processor 202 can include any suitable hardware processor, such as a microprocessor, a micro-controller, digital signal processor(s), dedicated logic, and/or any other suitable circuitry for controlling the functioning of a general purpose computer or a special purpose computer in some implementations.

Memory and/or storage 204 can be any suitable memory and/or storage for storing programs, data, media content, and/or any other suitable information in some implementations. For example, memory and/or storage 204 can include random access memory, read-only memory, flash memory, hard disk storage, optical media, and/or any other suitable memory.

Input device controller 206 can be any suitable circuitry for controlling and receiving input from one or more input devices 208 in some implementations. For example, input device controller 206 can be circuitry for receiving input from a touch screen, from one or more buttons, from a voice recognition circuit, from a microphone, from a camera, from an optical sensor, from an accelerometer, from a temperature sensor, from a near field sensor, and/or any other type of input device.

Display/audio drivers 210 can be any suitable circuitry for controlling and driving output to one or more display/audio output circuitries 212 in some implementations. For example, display/audio drivers 210 can be circuitry for driving an LCD display, a speaker, an LED, or any other type of output device.

Communication interface(s) 214 can be any suitable circuitry for interfacing with one or more communication networks, such as network 106 as shown in FIG. 1. For example, interface(s) 214 can include network interface card circuitry, wireless communication circuitry, and/or any other suitable type of communication network circuitry.

Antenna 216 can be any suitable one or more antennas for wirelessly communicating with a communication network in some implementations. In some implementations, antenna 216 can be omitted when not needed.

Bus 218 can be any suitable mechanism for communicating between two or more components 202, 204, 206, 210, and 214 in some implementations.

Any other suitable components can be included in hardware 200 in accordance with some implementations.

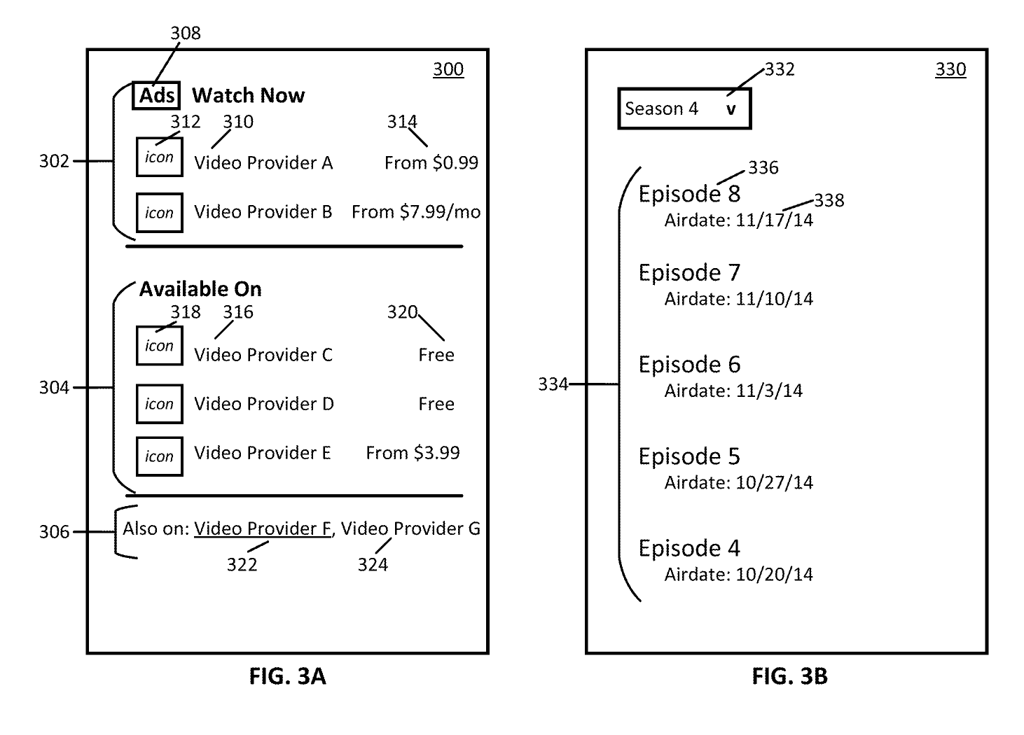

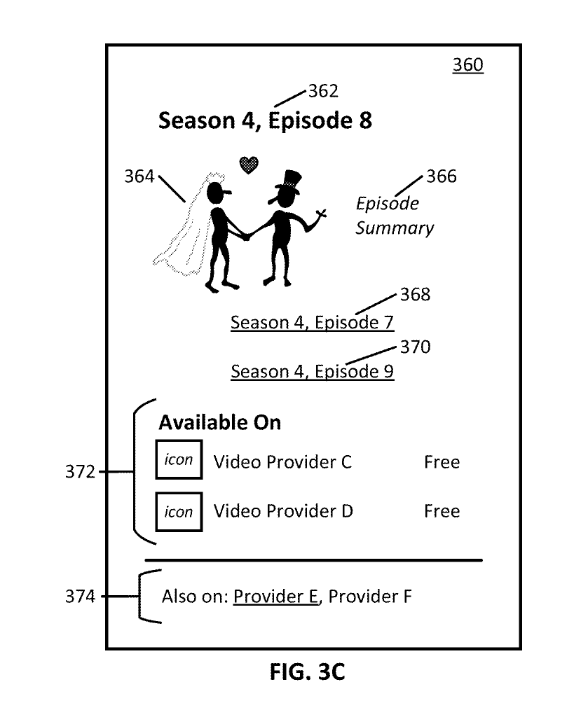

Turning to FIG. 3A, an example 300 of a user interface for presenting links to a media content item indicated in a search query is shown in accordance with some implementations of the disclosed subject matter. In some implementations, user interface 300 can be presented on a user device on which the search query was entered. As illustrated, user interface 300 includes group of advertisement links 302, group of links 304, and group of video provider names 306.

Group of advertisement links 302 can include any links to the media content item that an associated video provider paid to have included in user interface 300. Note that, in some implementations, group of advertisement links 302 can be omitted. In some implementations, group of advertisement links 302 can include an advertisement indicator 308, which can indicate that the links included in group of advertisement links 302 are advertisements.

In some implementations, group of advertisement links 302 can include individual links to the media content item indicated in the search query, where each link is associated with a different video provider. In some implementations, an individual link can include a video provider name 310, an icon 312, and a price 314 (or other suitable economic terms). Video provider name 310 can indicate the name of a provider of the media content item. For example, in some implementations, video provider name 310 can indicate the name of a web-based service that streams media content items. Icon 312 can be an icon associated with the video provider. In some implementations, icon 312 can include any suitable images, icons, graphics, animations, text, and/or any other suitable content. Price 314 can include a price associated with viewing the media content item. In some implementations, price 314 can indicate a price associated with a one-time viewing of the media content item. Additionally or alternatively, in some implementations, price 314 can indicate a price associated with a subscription to the video provider, such as a price associated with a monthly subscription. In some implementations, price 314 can indicate that viewing the media content item from the associated video provider would be free.

In some implementations, any of video provider name 310, icon 312, and/or price 314 can be hyperlinked to a page associated with the media content item and/or the video provider. For example, in some implementations, video provider name 310, icon 312, and/or price 314 can be hyperlinked to a page associated with the video provider that includes a video player window configured to play the media content item. As another example, in some implementations, video provider name 310, icon 312, and/or price 314 can be hyperlinked to a page that includes an advertisement for the video provider and/or a page allowing a user to sign up for a subscription associated with the video provider.

Group of links 304 can include any suitable links to the media content item. In some implementations, an individual link within group of links 304 can include a video provider name 316, an icon 318, and a price 320, which can be similar to video provider name 310, icon 312, and price 314 of group of advertisement links 302. Note that, in some implementations, the video providers that are included in group of links 304, as well as the order in which links associated with different video providers are presented within group of links 304, can be determined based on any suitable criteria and using any suitable technique(s), such as those described below in connection with FIGS. 4 and 5.

In some implementations, any of video provider name 316, icon 318, and/or price 320 can be hyperlinked. For example, in some implementations, selection of video provider name 316, icon 318, and/or price 320 can cause the media content item to begin being presented (e.g., by causing the media content to be streamed from the video provider to the user device).

Group of video provider names 306 can include names of video providers (e.g., provider names 322 and 324) that provide access to the media content item. In some implementations, video providers included in group of video provider names 306 can be video providers that are less relevant (e.g., based on any suitable criteria, as shown in and described below in connection with FIGS. 4 and 5) than those included in group of links 304. For example, in some implementations, video providers included in group of video provider names 306 can be those that do not support presentation of the media content item on the particular user device on which user interface 300 is presented. As another example, in some implementations, video providers included in group of text links 306 can be those that do not directly provide links to the media content item.

As shown in FIG. 3A, video provider names included in group of video provider names 306 can be hyperlinked (e.g., as shown by video provider name 322). In some implementations, the hyperlink can link to a page associated with the media content item and/or a page associated with the video provider. Alternatively, in some implementations, video provider names included in group of video provider names 306 can include text that is not hyperlinked, as shown by video provider name 324. In some implementations, a determination of whether a video provider name is to be hyperlinked can be based on any suitable criteria, as described below in connection with FIGS. 4 and 5.

Turning to FIG. 3B, an example 330 of a user interface for presenting episodes associated with a television program indicated in a search query is shown in accordance with some implementations of the disclosed subject matter. As illustrated, user interface 330 can include a season indicator 332 and a list of episodes 334.

Season indicator 332 can indicate a particular season associated with a television program. As shown in FIG. 3B, in some implementations, season indicator 332 can include a user interface control for changing the season associated with list of episodes 334. For example, in some implementations, season indicator 332 can include a drop-down menu and/or any other suitable user interface control.

List of episodes 334 can include any suitable number of episodes associated with a season indicated by season indicator 332. In some implementations, a particular episode included in list of episodes 334 can include an episode name 336 and an airdate 338.

Episode name 336 can include any suitable text, images, icons, graphics, animations, and/or any other suitable content associated with a name of an episode. For example, in some implementations, episode name 336 can include a name of the episode, one or more names of characters and/or actors featured in the episode, one or more images of scenes and/or characters from the episode, and/or any other suitable content.

Airdate 338 can include any suitable indication of a date associated with the episode. For example, in some implementations airdate 338 can include a date the episode was broadcast, a date the episode was made available on a video streaming service, and/or any other suitable date. In some implementations airdate 338 can be omitted.

In some implementations, episode name 336 and/or airdate 338 can be hyperlinked. In some implementations, selection of a link associated with episode name 336 and/or airdate 338 can cause a user interface presenting additional information about the selected episode to be presented. FIG. 3C shows an example 360 of a user interface that can be presented in response to determining that a particular episode in user interface 330 has been selected in accordance with some implementations of the disclosed subject matter. As illustrated, user interface 360 can include a title 362, an image 364, an episode summary 366, other episodes 368 and 370, group of links 372, and group of video provider names 374.

Title 362 can be any suitable indication of content of user interface 360. In some implementations, title 362 can include any suitable text, images, icons, graphics, animations, and/or any other suitable content. In some implementations, title 362 can be omitted.

Image 364 can include any suitable image associated with the selected episode. For example, in some implementations, image 364 can include a screen capture from a scene in the selected episode. As another example, in some implementations, image 364 can include an image of a character and/or actor featured in the selected episode. Note that the position of image 364 within user interface 360 is shown as an example, and image 364 can be located at any suitable position. In some implementations, image 364 can be omitted.

Episode summary 366 can include any suitable text related to the selected episode. For example, in some implementations, episode summary 366 can include a synopsis of the selected episode. As another example, in some implementations, episode summary 366 can include names of one or more characters featured in the selected episode. Note that the position of episode summary 366 within user interface 360 is shown as an example, and episode summary 366 can be located at any suitable position. In some implementations, episode summary 366 can be omitted.

Other episodes 368 and/or 372 can include links to episodes related to the selected episode. For example, as shown in FIG. 3C, other episodes 368 and 372 can include links to an episode that occurred before the selected episode and an episode that occurred after the selected episode, respectively. Note that, although two other episodes are shown in FIG. 3C, in some implementations, any suitable number (e.g., one, three, five, and/or any other suitable number) can be included. In some implementations, other episodes 368 and/or 372 can be omitted.

In some implementations, group of links 372 and group of video provider names 374 can be similar to group of links 304 and group of video provider names 306 as shown in and described above in connection with FIG. 3A. For example, in some implementations, selection of a link in group of links 372 can cause the selected episode to begin being presented. As a more particular example, in some implementations, selection of the link can cause the associated video provider to begin streaming a video file associated with the selected episode to the user device via communication network 106. Note that, in some implementations, selection of video providers included in group of links 372 and group of video provider names 374, as well as the order in which video providers are presented within each group can be based on any suitable criteria, as described below in connection with FIGS. 4 and 5.

Turning to FIG. 4, an example 400 of a process for receiving a search query for a particular media content item, ranking providers of the media content item, and presenting a user interface based on the ranking is shown in accordance with some implementations of the disclosed subject matter.

Process 400 can begin by receiving, from a user device, a search query for a media content item at 402. For example, in some implementations, the search query can include a name of a particular television program and/or or a particular movie. As another example, in some implementations, the search query can include a name and/or an identifier of a particular episode of a particular television program. In a more particular example, the search query can be inputted into a search interface presented by a media guidance application. In another more particular example, the search query can include selecting an indicator associated with playing back a media content item (e.g., selecting a play icon in an interface provided by the media guidance application or any other suitable watch action).

It should be noted that, in some implementations, the received search query can include a particular content provider (e.g., “I want to watch comedy movies on Provider X.”). In response, the ranking of candidate providers with access to the media content item can take into account the query information. For example, the candidate providers can be ranked as described in connection with FIG. 5 and the particular content provider mentioned in the received search query can be promoted to the top of the rank-ordered list of candidate providers for presentation in a user interface. In another example, the particular content provider mentioned in the received search query can be visually identified in the user interface (e.g., highlighted).

Process 400 can identify candidate providers with access to the media content item at 404. In some implementations, the candidate providers can include any suitable media content providers, such as web-based streaming media content services, subscription-based streaming media content services, media content management services, services that provide media content for download, video-on-demand content services that provide media content through a multichannel video programming distributor, on-demand content that provides media content through an over-the-top provider, and/or any other type of media content providers. Process 400 can use any suitable information and/or any suitable technique(s) to identify the candidate providers. For example, in some implementations, process 400 can access a list and/or a table of video providers and can determine whether each of the video providers provides access to the media content item. In another example, in some implementations, process 400 can use an application program interface associated with each of the video providers to determine whether a video provider provides access to the media content item. In some implementations, process 400 can generate a group of candidate providers to include the known video providers that provide access to the media content item.

Process 400 can determine whether each of the candidate providers is associated with an application, such as a downloadable mobile device application, at 406. In some implementations, the application can be a program associated with the candidate provider that can be downloaded, installed, and executed on a user device, such as a mobile phone, a tablet computer, a wearable computer, a laptop computer, and/or any other suitable user device. In some implementations, multiple applications can be associated with a candidate provider, such as an application suitable for a mobile device, an application suitable for a desktop computing device, and an application suitable for a media playback device (e.g., a streaming media device). Process 400 can use any suitable information and/or technique(s) to determine whether each of the candidate providers is associated with one or more applications. For example, in some implementations, process 400 can access an online store to determine whether an application associated with a particular candidate provider is available for download. As another example, in some implementations, process 400 can access a list and/or a table that indicates applications associated with different candidate providers.

At 408, for candidate providers determined to be associated with applications, process 400 can receive information relating to the application and the particular media content item indicated in the search query. For example, in some implementations, process 400 can receive information indicating whether the application provides deep links (e.g., links to a particular web page, links to a particular web page directly associated with the media content item, and/or any other suitable type of deep link). As another example, in some implementations, process 400 can receive information indicating whether the application is an official provider of the media content item. As a more particular example, process 400 can receive information indicating whether the application and/or a video provider associated with the application is the only application and/or video provider that provides access to the media content item, and/or access to the media content item at a particular price (e.g., for free, for free with a subscription, and/or any other suitable price). As yet another example, in some implementations, process 400 can receive information indicating a price of a media content item if it were purchased and/or viewed using the application and/or a video provider associated with the application. As a more particular example, the price can indicate a price associated with permanently downloading the media content item, a price associated with streaming the media content item once, a price associated with a subscription to the video provider that allows access to the media content item, and/or any other suitable price.

In some implementations, process 400 can receive information related to the application and the media content item from any suitable source. For example, in some implementations, process 400 can receive the information from a media content server 102 associated with the video provider corresponding to the application. Additionally or alternatively, in some implementations, process 400 can receive the information from data server 104.

Process 400 can receive information relating to previous interactions between a user of the user device and each of the candidate providers at 410. For example, in some implementations, the received information can indicate whether the user has previously accessed a service and/or a web page associated with the candidate provider. As another example, in some implementations, the received information can indicate whether the user has installed an application associated with the candidate provider on the user device. As yet another example, in some implementations, the received information can indicate whether the user has a subscription to a service associated with the candidate provider (e.g., one that allows unlimited viewing for a monthly fee, one that allows a particular number of downloads per month, and/or any other suitable type of subscription). As still another example, in some implementations, the received information can indicate how recently and/or how frequently the user has accessed a service associated with the candidate provider and/or an application associated with the candidate provider. As a specific example, the received information can indicate that the user last accessed the application a month ago, that the user has accessed the application twice in the last week, and/or any other suitable metric. In some implementations, previous interactions of the user can be associated with any user device, including user devices not associated with the received search query. In some such implementations, previous interactions can be determined based on a common user account used that is used multiple times across user devices.

In some implementations, process 400 can receive information relating to previous interactions between a user of the user device and each of the candidate providers from any suitable source. For example, in some implementations, information relating to applications installed on the user device can be determined from information stored on the user device. As another example, in some implementations, process 400 can receive information relating to whether a user has a subscription to a particular service associated with a candidate provider from data server 104 (e.g., in association with a particular user account identifier). Note that, in some implementations, information relating to previous actions between the user and each of the candidate providers can be synchronized across multiple user devices based on a user account associated with the user that has been authenticated on each of the multiple user devices. In some such implementations, consent to use information across the multiple user devices can be requested before the information is used by process 400.

Process 400 can receive information relating to a popularity of each of the candidate providers at 412. For example, in some implementations, the received information can indicate a total number of users of a particular candidate provider, an average number of users per time period (e.g., a number of users per hour, a number of users per day, and/or over any other suitable time period), a number of users within a particular demographic group (e.g., a number of users within a particular age range, and/or any other suitable demographic group), a number of subscribers to a service provided by a candidate provider, a number of downloads of an application associated with a candidate provider, and/or any other suitable popularity metric.

In some implementations, process 400 can receive the information relating to the popularity of each of the candidate providers from any suitable source. For example, in some implementations, process 400 can receive the information from a media content server 102 associated with a particular candidate provider. Additionally or alternatively, in some implementations, process 400 can receive the information from data server 104.

Process 400 can rank the candidate providers using any combination of the received information at 414 and using any suitable technique or combination of techniques. For example, in some implementations, process 400 can generate a ranking score for each of the candidate providers using the received information, using the techniques shown in and described below in connection with FIG. 5. Process 400 can then rank the candidate providers based on the generated ranking scores.

Process 400 can cause a user interface with links to the media content item to be presented based on the ranking of the candidate providers to be presented at 416. In some implementations, the user interface can include links provided as advertisements, as shown in and discussed above in connection with FIG. 3A. Additionally, in some implementations, the user interface can include links to the media content item associated with different candidate providers, as shown in group of links 304 of FIG. 3A. In some implementations, inclusion in group of links 304 can be based on the ranking of candidate providers. For example, in some implementations, the top N (e.g., one, two, three, and/or any other suitable number) candidate providers can be included in group of links 304. As another example, in some implementations, only candidate providers that meet particular criteria (e.g., that include a direct link to the media content item, that provide free access to the media content item, and/or any other suitable criteria) can be included in group of links 304. In some implementations, process 400 can cause candidate providers that are not in the top N candidate providers and/or candidate providers that do not meet particular criteria to be listed in group of links 304 to be listed in group of provider names 306, as shown in and discussed above in connection with FIG. 3A.

Note that, in some implementations, process 400 can additionally or alternatively cause links to applications that have been determined to not be installed on the user device to be presented in the user interface. In some such implementations, selection of the link can cause a page for initiating download of the application to be presented. Additionally or alternatively, in some implementations, selection of the link can cause the application to be downloaded on a different user device. For example, in some such implementations, selection of the link can cause a user interface indicating nearby detected user devices to be presented, and the user can select one of the detected user devices to download the application.

As discussed above in connection with FIG. 3A, selection of a particular link presented in the user interface can cause the associated media content item to be downloaded from the corresponding video provider and/or streamed to a user device from the corresponding video provider. In some implementations, the user device can be one on which user interface 300 of FIG. 3A is presented. Alternatively, in some implementations, the user device can be a different user device (e.g., one with a connection to the user device on which user interface 300 is presented, such as a connected television, a connected desktop computer, etc.). For example, in some implementations, one or more nearby user devices can be detected using any suitable device detection protocol, and selection of the particular link the user interface can cause the associated media content item to be presented on one of the detected nearby user devices.

Turning to FIG. 5, an example 500 of a process for generating a ranking score for a particular candidate provider that can be used to rank candidate providers is shown in accordance with some implementations of the disclosed subject matter. Note that, in some implementations, process 500 can be repeated for each of the candidate providers identified by process 400 to generate a ranking score for each candidate provider, and the candidate providers can then be ranked using the ranking scores, as described above in connection with block 414 of FIG. 4.

Process 500 can begin by determining whether the particular candidate provider supports deep links at 502. As described above in connection with block 408 of FIG. 4, deep links can include any suitable links to a particular page on a web site associated with the provider and/or a link to a particular page associated with the media content item on a web site associated with the provider. In some implementations, process 500 can determine whether the provider supports deep links by accessing a list and/or a table that specifies whether different providers support deep links.

If, at 502, it is determined that the provider supports deep links (“Yes” at 502), process 500 can calculate Score 1 at 504. In some implementations, Score 1 can be a score on any suitable scale. For example, in some implementations, Score 1 can be a binary score (e.g., 1 if the provider supports deep links).

Process 500 can continue to 506, and can determine whether the user has a subscription to a service provided by the particular candidate provider. As described above in connection with block 410 of FIG. 4, process 500 can receive information indicating that the user has a subscription from any suitable source, such as a user device and/or data server 104. In some implementations, process 500 can use an identifier (e.g., a username, and/or any other suitable identifier) associated with a user account to determine whether the user has a subscription.

If, at 506, it is determined that the user has a subscription to a service provided by the candidate provider (“Yes” at 506), process 500 can calculate Score 2 at 508. Similarly to Score 1, Score 2 can be a score on any suitable scale. For example, in some implementations, Score 2 can be a binary score (e.g., 1 if the user has a subscription to the service).

Process 500 can continue to 510, and can determine whether an application associated with the particular candidate provider has been installed on a particular user device. As described above in connection with block 410 of FIG. 4, process 500 can receive information indicating whether the application has been installed from any suitable source, such as the particular user device and/or data server 104.

If, at 510, it is determined that the application has been installed (“Yes” at 510), process 500 can calculate Score 3 at 512. Similarly to Score 1 and Score 2, Score 3 can be a score on any suitable scale. For example, in some implementations, Score 3 can be a binary score (e.g., 1 if the application has been installed).

Process 500 can continue to 514, and can determine whether the candidate provider is the only provider of the media content item. As described above in connection with block 408 of FIG. 4, process 500 can determine whether the candidate provider is the only provider of the content using information received from any suitable source, such as a media content server associated with the provider and/or data server 104.

If, at 514, it is determined that the candidate provider is the only provider of the media content item (“Yes” at 514), process 500 can calculate Score 4 at 516. Similarly to Score 1, Score 2, and Score 3, Score 4 can be a score on any suitable scale. For example, in some implementations, Score 4 can be a binary score (e.g., 1 if the provider is the only provider of the media content item).

Process 500 can continue to 518, and can determine whether the candidate provider provides free access to the media content item. As described above in connection with block 408 of FIG. 4, process 500 can determine the price using information received from any suitable source, such as a media content server associated with the candidate provider and/or data server 104.

If, at 518, it is determined that the candidate provider provides free access to the media content item (“Yes” at 518), process 500 can calculate Score 5 at 518. Similarly to Score 1, Score 2, Score 3, and Score 4, Score 5 can be a score on any suitable scale. For example, in some implementations, Score 5 can be a binary score (e.g., 1 if the media content item is free).

Note that, in some implementations, process 500 can calculate Score 5 based on the price of the media content item, regardless of whether access to the media content item is free. For example, in some implementations, process 500 can calculate Score 5 such that Score 5 has an inverse relationship to the price. As a more particular example, in some implementations, Score 5 can be higher for relatively lower priced and/or free items compared to relatively higher priced items.

Process 500 can continue to 520, and can determine whether a link to the media content item provided by the candidate provider is to an application rather than to a web page. In some implementations, process 500 can determine whether the link is to an application rather than to a web page based on a Universal Resource Locator (URL) associated with the link.

If, at 520, it is determined that the link to the content provided by the candidate provider is to an application (“Yes” at 520), process 500 can calculate Score 6 at 524. Similarly to Score 1, Score 2, Score 3, Score 4, and Score 5, Score 6 can be a score on any suitable scale. For example, in some implementations, Score 6 can be a binary score (e.g., 1 if the link is to the media content item through an application).

Process 500 can continue to 526, and can calculate Score 7 based on how recently and/or how frequently a user of the user device has accessed an application associated with the candidate provider and/or a web page associated with the candidate provider. As described above in connection with block 410 of FIG. 4, process 500 can receive information relating to the user's previous interactions with the candidate provider from any suitable source, such as the user device and/or data server 104. In some implementations, Score 7 can be on any suitable scale. For example, in some implementations Score 7 can be calculated such that relatively higher scores correspond to a more recent usage and/or a more frequent usage of the application and/or the web page associated with the provider. In some implementations, Score 7 can be calculated using any suitable techniques. For example, in some implementations, process 500 can use a look-up table that uses how recently and/or how frequently the service and/or application were used as indices of the table. As another example, in some implementations, process 500 can use a formula that uses metrics of how recently and/or how frequently the service and/or the application were used to calculate Score 7.

Process 500 can calculate Score 8 based on a popularity associated with the candidate provider at 528. As described above in connection with block 412 of FIG. 4, process 500 can receive information relating to the popularity of the candidate provider from any suitable source, such as data server 104. In some implementations, Score 8 can be on any suitable scale. For example, in some implementations, Score 8 can be calculated such that relatively higher scores correspond to a higher popularity metric. Similarly to Score 7, Score 8 can be calculated using any suitable technique(s), such as a look-up table and/or a formula.

Process 500 can, in some implementations, aggregate Scores 1-8 to generate a ranking score for the particular candidate provider at 530 using any suitable technique(s). For example, in some implementations, the aggregate ranking score can be calculated as a weighted sum of Scores 1-8. In some such implementations, any suitable weighting can be used for each of Scores 1-8. Note that, in some implementations, if any of blocks 502, 506, 510, 514, 518, and 522 result in “No,” the corresponding score can be set by default to be 0 for the purpose of calculating the aggregate ranking score.

It should be understood that at least some of the above described blocks of the processes of FIGS. 4 and 5 can be executed or performed in any order or sequence not limited to the order and sequence shown in and described in the figure. Also, some of the above blocks of the processes of FIGS. 4 and 5 can be executed or performed substantially simultaneously where appropriate or in parallel to reduce latency and processing times. Additionally or alternatively, some of the above described blocks of the processes of FIGS. 4 and 5 can be omitted.

In some implementations, any suitable computer readable media can be used for storing instructions for performing the functions and/or processes herein. For example, in some implementations, computer readable media can be transitory or non-transitory. For example, non-transitory computer readable media can include media such as magnetic media (such as hard disks, floppy disks, and/or any other suitable magnetic media), optical media (such as compact discs, digital video discs, Blu-ray discs, and/or any other suitable optical media), semiconductor media (such as flash memory, electrically programmable read-only memory (EPROM), electrically erasable programmable read-only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

In situations in which the systems described here collect personal information about users, or make use of personal information, the users may be provided with an opportunity to control whether programs or features collect user information (e.g., information about a user's social network, social actions or activities, profession, a user's preferences, or a user's current location). In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Accordingly, methods, systems, and media for presenting links to media content are provided.

Although the invention has been described and illustrated in the foregoing illustrative implementations, it is understood that the present disclosure has been made only by way of example, and that numerous changes in the details of implementation of the invention can be made without departing from the spirit and scope of the invention, which is limited only by the claims that follow. Features of the disclosed implementations can be combined and rearranged in various ways.

What is claimed is:

1. A method for presenting links to media content, the method comprising:
receiving, from a user device, a search query for a media content item;
identifying a plurality of candidate providers that provide access to the media content item;
receiving, for each of the plurality of candidate providers, provider interaction information relating to previous interactions between a user of the user device and a candidate provider;
receiving, for each of the plurality of candidate providers, media link information related to links to the media content item by the candidate provider;
ranking the plurality of candidate providers based on the provider interaction information and the media link information;
identifying a subset of the plurality of candidate providers to be associated with a presented link to the media content item based at least in part on the ranking; and
causing a user interface with a plurality of links to the media content item to be presented, wherein each link of the plurality of links is associated with one of the subset of the plurality of candidate providers.

2. The method of claim 1, wherein the provider interaction information indicates whether the user has subscribed to a service provided by the candidate provider.

3. The method of claim 1, wherein the provider interaction information indicates whether an application associated with the candidate provider has been installed on the user device.

4. The method of claim 1, wherein the provider interaction information indicates how recently the user device accessed the candidate provider.

5. The method of claim 1, further comprising identifying a price associated with access to the media content item by each of the plurality of candidate providers, wherein ranking the plurality of candidate providers is based at least in part on the price.

6. The method of claim 1, further comprising receiving information indicating a popularity of each of the plurality of candidate providers, wherein ranking the plurality of candidate providers is based at least in part on the popularity.

7. A system for presenting links to media content, the system comprising:
a hardware processor that is programmed to:
receive, from a user device, a search query for a media content item;
identify a plurality of candidate providers that provide access to the media content item;
receive, for each of the plurality of candidate providers, provider interaction information relating to previous interactions between a user of the user device and a candidate provider;
receive, for each of the plurality of candidate providers, media link information related to links to the media content item by the candidate provider;
rank the plurality of candidate providers based on the provider interaction information and the media link information;
identify a subset of the plurality of candidate providers to be associated with a presented link to the media content item based at least in part on the ranking; and
cause a user interface with a plurality of links to the media content item to be presented, wherein each link of the plurality of links is associated with one of the subset of the plurality of candidate providers.

8. The system of claim 7, wherein the provider interaction information indicates whether the user has subscribed to a service provided by the candidate provider.

9. The system of claim 7, wherein the provider interaction information indicates whether an application associated with the candidate provider has been installed on the user device.

10. The system of claim 7, wherein the provider interaction information indicates how recently the user device accessed the candidate provider.

11. The system of claim 7, wherein the hardware processor is further programmed to identify a price associated with access to the media content item by each of the plurality of candidate providers, wherein ranking the plurality of candidate providers is based at least in part on the price.

12. The system of claim 7, wherein the hardware processor is further programmed to receive information indicating a popularity of each of the plurality of candidate providers, wherein ranking the plurality of candidate providers is based at least in part on the popularity.

13. A non-transitory computer-readable medium containing computer executable instructions that, when executed by a processor, cause the processor to perform a method for presenting links to media content, the method comprising:
receiving, from a user device, a search query for a media content item;
identifying a plurality of candidate providers that provide access to the media content item;
receiving, for each of the plurality of candidate providers, provider interaction information relating to previous interactions between a user of the user device and a candidate provider;
receiving, for each of the plurality of candidate providers, media link information related to links to the media content item by the candidate provider;
ranking the plurality of candidate providers based on the provider interaction information and the media link information;
identifying a subset of the plurality of candidate providers to be associated with a presented link to the media content item based at least in part on the ranking; and
causing a user interface with a plurality of links to the media content item to be presented, wherein each link of the plurality of links is associated with one of the subset of the plurality of candidate providers.

14. The non-transitory computer-readable medium of claim 13, wherein the provider interaction information indicates whether the user has subscribed to a service provided by the candidate provider.

15. The non-transitory computer-readable medium of claim 13, wherein the provider interaction information indicates whether an application associated with the candidate provider has been installed on the user device.

16. The non-transitory computer-readable medium of claim 13, wherein the provider interaction information indicates how recently the user device accessed the candidate provider.

17. The non-transitory computer-readable medium of claim 13, wherein the method further comprises identifying a price associated with access to the media content item by each of the plurality of candidate providers, wherein ranking the plurality of candidate providers is based at least in part on the price.

18. The non-transitory computer-readable medium of claim 13, wherein the method further comprises receiving information indicating a popularity of each of the plurality of candidate providers, wherein ranking the plurality of candidate providers is based at least in part on the popularity.
